(19) United States
(12) Patent Application Publication
(10) Pub. No.: US 2006/0075916 A1
(43) Pub. Date: Apr. 13, 2006

(54) System and method for ink jet printing of water-based inks using aesthetically pleasing ink-receptive coatings

(76) Inventors: Paul A. Edwards, Ypsilanti, MI (US); Steve Childs, Cambs (GB)

Correspondence Address: HARNESS, DICKEY & PIERCE, P.L.C., P.O. BOX 828, BLOOMFIELD HILLS, MI, 48303, US

(21) Appl. No.: 10/961,540

(22) Filed: Oct. 8, 2004

(51) Int. Cl. B41F 33/00

(52) U.S. Cl. 101/483

(57) ABSTRACT

A system and method for printing aqueous ink jet ink in selected areas of nonabsorbent and semi-nonabsorbent substrates includes applying an ink-receptive coating having an aesthetically pleasing appearance in the selected areas, for example with printing station having a printing and drying unit for applying the ink-receptive coating in the desired area or areas of the substrate and then drying the coating, and printing an aqueous ink jet ink in the coated area with a CIJ, TIJ, pr PIJ printer. Variable print may be printed with the ink jet ink in a high speed process.

### FIELD OF THE INVENTION

The invention relates to systems and methods for ink jet printing, including drop-on-demand (DOD) technologies such as thermal ink jet (TIJ) and piezoelectric ink jet (PIJ) and particularly including continuous ink jet (CIJ) printing, using aqueous inks.

### BACKGROUND OF THE INVENTION

High-speed printing of variable images, such as variable text, numbers, bar codes, or graphics, is often done by continuous ink jet (CIJ) printing due to its high speed, but new TIJ and PIJ printing systems can often be used in these high speed applications also. The article to which the variable print is applied may be a paper web being printed on a press, rolls of packaging materials such as plastics, or products that have already been formed. In general, the substrate is printed in full color with process colors before the variable text is applied. Conventional presses have five or more printing stations, one each for application of cyan, magenta, yellow, and black plus additional printing stations for printing spot colors, applying a glossy coating, for printing enhanced process color sets with six, seven, or more colors, and so on. A printing station will include the ink application rollers and may also include a heat dryer or actinic radiation source. An ink jet printer may be located in-line with press where the variable image is applied as a (usually final) printing step, or the continuous ink jet printer may be in another location for off-line application of the variable image, e.g. at a mail table where addresses are added to stacks of already-printed material.

Printing water-based ink jet inks is preferred because it avoids the hazards and regulated emissions of solvent-based inks. Water-based inks have been restricted by their nature, however, to printing on very porous substrates that can quickly absorb the water in the ink so that the drying period is short for subsequent handling of the printed substrate. Water-absorption of the substrate may be enhanced by ink-receptive coatings applied to one or both faces of the substrate. Coated papers have a generally low gloss. Thus, high speed binary array systems such as Scitex® one-inch, two-inch, and four-inch printers (available from Kodak Versamark) or printers based on Hewlett-Packard TIJ heads have been used in high speed printing of water-based inks onto absorbent and partially absorbent papers only.

High-speed jet printing with water-based inks has not been successful for nonabsorbent substrates or substrates with little absorbency (semi-nonabsorbent substrates) such as high gloss stock. Nonabsorbent and semi-nonabsorbent substrates may be used in printing magazine cover and packaging, for instance, for which it would also be desirable to use a binary ink jet station to imprint variable text, numbers, bar codes, or graphics onto selected areas of the substrate for, e.g., product coding, addressing, or customizing. When water-based ink is printed at the ink jet station on nonabsorbent substrates, the presses must either be run at low speeds or given long drying tracks to accommodate the slow evaporation of water in drying the ink because the ink must dry before the print reaches a turnover roller to prevent smearing. Both running the presses at slow speed and using long drying tracks are undesirable as inefficient and costly. A drying station may be installed if there is room, but again this adds to cost.

Attempts have been made to adjust the ink formulation to achieve greater penetration on semi-impermeable stock with modest improvements of perhaps 10-15 percent in the drying rate. Formulating at higher solids and with polymeric dyes to reduce the amount of water in the ink to evaporate may also reduce drying rate by 20 or 30 percent, but these high solids inks also have higher viscosities and cannot be printed using conventional ink jet printers.

The application “SYSTEM AND METHOD FOR INK JET PRINTING OF WATER-BASED INKS USING INK-RECEPTIVE COATINGS” filed on even date herewith teaches a system and method for printing aqueous ink jet ink in selected areas of nonabsorbent and semi-nonabsorbent substrates. The system and method include applying an ink-receptive coating in the selected areas, for example with printing station having a printing and drying unit for applying the ink-receptive coating in the desired area or areas of the substrate, drying the coating, and printing an aqueous ink jet ink in the coated area with a CIJ, TIJ, or PIJ printer. This method makes it possible to apply aqueous ink jet ink to nonabsorbent substrates without expensive modification of the print equipment and without the delay that a long drying track would impose. Such ink receptive coatings are matt. If the rest of the print is glossy or semi-gloss (silky) and the ink-receptive coating is matt, however, the visible difference in gloss between the coated area or areas and the rest of the print may be undesirable. Further, the ink-receptive coating may be applied in an area printed with a highlight color. Even though the ink-receptive coating may be translucent, its content of absorbent particles may cause the coated, highlighted area to appear discolored, e.g. “grayed off,” in comparison to the uncoated highlight areas. Thus, while ink jet printing aqueous inks over a selected area or areas coated with ink-receptive coating is beneficial in itself, there would be further benefits to using ink-receptive coatings that have gloss or color, or both, aesthetically pleasing on the printed substrate.

### SUMMARY OF THE INVENTION

The present invention provides a system and method for printing aqueous ink, particularly by CIJ, TIJ, or PIJ, in selected areas of nonabsorbent and semi-nonabsorbent substrates. The system has a press with a coating station having a printing and, preferably, a drying unit for applying an ink-receptive coating that will provide an aesthetically pleasing appearance on the desired area or areas of the substrate and an ink jet printer positioned to apply a variable print in the coated area. An aesthetically pleasing appearance has an acceptable match of gloss or color, or both gloss and color, with print in an adjacent, uncoated area, or has provides a highlight or contrasting color to the coated area. Optionally, a dryer may be used to dry or cure the ink-receptive coating as needed before the ink jet printer, or the coating may dry by air. The coated substrate may pass through further print stations where ink is applied. An “ink receptive coating” is a coating that readily absorbs the ink. Since the ink is readily absorbed, the drop spread is minimal and the printed substrate can be further handled as though it were dry. It is believed that the ink, or at least the water in the ink, is trapped in the receptive coating matrix and/or porous particles, and dries over time. The ink-receptive coating contains the ink and the surface is not tacky.

In one embodiment, the invention provides a system for printing nonabsorbent and semi-absorbent substrates, the system including a printing press having at least five stations, one of which is used to apply an ink-receptive coating that will provide an aesthetically pleasing appearance to the desired area or areas of a substrate. The system further includes an ink jet printer positioned to apply a variable print in the coated area. A substrate coated in this way includes a variable text in a coated area having an acceptable match in appearance to an adjacent, uncoated area or a highlight or contrasting color in the coated area.

The present invention provides a method of printing an aqueous ink jet ink in at least one selected area of a substrate that will provide an aesthetically pleasing appearance on the selected area, in which an ink-receptive coating is applied in the selected area before the ink jet ink is printed. The applied coating has a desired gloss (e.g., semi-gloss or glossy appearance) and/or a desired color. In various embodiments, one or more of variable text, numbers, bar codes, or graphics are printed with an aqueous ink jet ink in the at least one selected area of the substrate. Also in various embodiments, a heater or source of actinic radiation is used to dry or cure the coating before the aqueous ink jet ink is printed in the coated area.

Applying an ink-receptive coating can provide substantial improvements in the drying rate of an ink jet print (as determined by when the print can be handled or processed, e.g., rolled), such as 50 to 90 percent, and applying an ink-receptive coating that will provide an aesthetically pleasing appearance on the substrate may make the coated areas less noticeable and better match adjacent printed area or areas that are not coated, or may be used to provide highlight or contrasting color in the variable print area. Using the inventive method or system, even nonporous substrates, such as very high gloss stock, metal, coated substrates, and plastics, can be printed with a continuous ink jet printing without long drying tracks, slow printing speeds, or costly or inefficient modifications to the press and with aesthetically pleasing appearance. The print quality is substantially improved, and there is more consistency in print quality between different substrates.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates a possible variation of up to 5% in the value.

### BRIEF DESCRIPTION OF THE DRAWINGS

The present invention will become more fully understood from the detailed description and the accompanying drawings, wherein:

FIG. 1 is a block diagram of an embodiment of a system of the invention for web printing;

FIG. 2 is a block diagram of a mail table embodiment of the invention; and

FIG. 3 illustrates an area of a substrate printing using a method of the invention.

### DETAILED DESCRIPTION OF THE PREFERRED EMBODIMENTS

The following description of the preferred embodiment(s) is merely exemplary in nature and is in no way intended to limit the invention, its application, or uses.

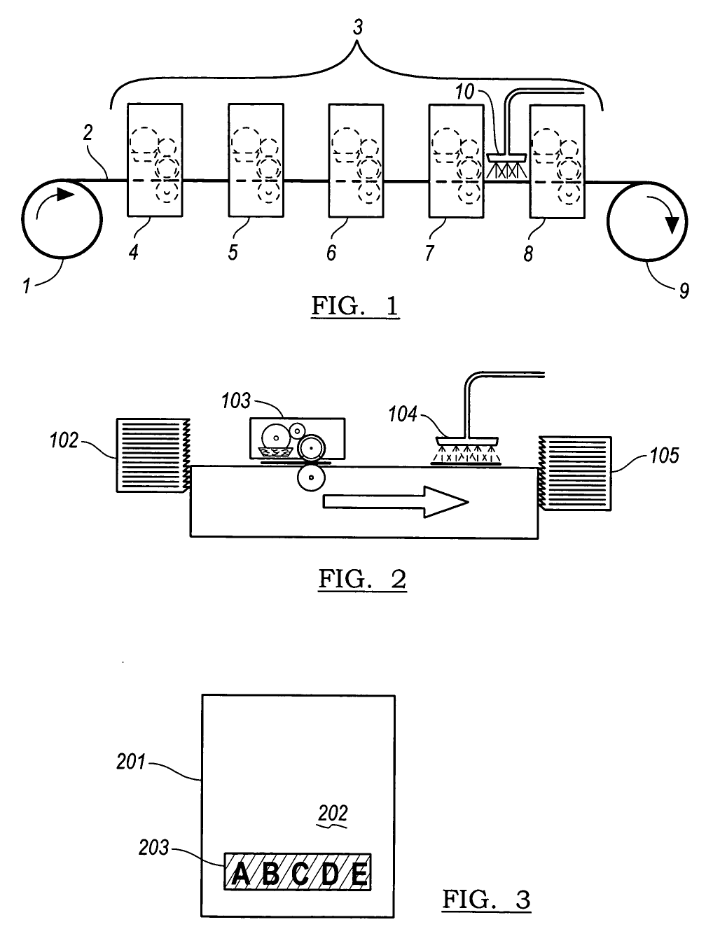

The inventive system and method provide a means of printing aqueous ink jet ink in selected areas of nonabsorbent and semi-nonabsorbent substrates. The system has a press with a coating station having a printing unit and, optionally, a heat or radiative source for applying an ink-receptive coating with an aesthetically pleasing appearance to the desired area or areas of the substrate and then drying or curing the coating and a CIJ, TIJ, or PIJ printer positioned to apply a variable print in the coated area. Referring first to FIG. 1, a web 2 of a nonabsorbent and semi-nonabsorbent substrate unwinds from roll 1, passes through press 3 having five printing stations 4, 5, 6, 7, and 8 and rolls up on roll 9. Press 3 may, for example, print by flexography or by intaglio or gravure. An ink jet printing unit 10 prints a desired area of the substrate between printing stations 7 and 8.

The ink-receptive coating may be applied using a print station already available on the press and, therefore, no additional equipment must be installed. The press illustrated In FIG. 1 has five print stations, but other presses may have more than five print stations. For example, then, in FIG. 1 one of print stations 4-7 may be selected to apply an ink-receptive coating onto the substrate. The coating is printed onto a specific area, or more than one specific area, on the substrate. If there is at least one additional print station between the print station applying the coating and the CIJ, TIJ, or PIJ printer, the coating may dry sufficiently before it reaches the ink jet print head without heat, or may be dried by a heat source associated with the additional print station or stations. Thus, referring again to FIG. 1, the ink receptive coating may be applied with one of print stations 4, 5, or 6, then dried without heat before reaching ink jet printing unit 10, or the ink receptive coating may be dried by a heat source or cured by a radiative source located after the coating is applied. The applied coating may not need to dry fully before reaching the CIJ, TIJ, or PIJ printhead, so long as it attains sufficient ink receptiveness so that when the surface contacts a roller or other equipment the ink jet print remains acceptable in appearance. The ink-receptive coating may also be applied in print station 7, particularly if the print station includes or is followed by a thermal dryer or if the coating is cured with actinic radiation.

Examples of nonabsorbent or semi-nonabsorbent substrates include, without limitation, high gloss, satin, or coated paper or paperboard and plastic (e.g., polyethylene, polypropylene, vinyl, or polyester), which may be supplied as webs, rolls, or sheets, as well as plastic and metal packaging materials.

The press may be, for example, a flexographic press or gravure press. In various other embodiments, the ink-receptive coating may be applied to the desired area(s) by pad printing, spray printing, or ink jet printing.

Typical ink-receptive coating compositions are aqueous and include a polymer or resin, preferably one or more film-forming polymers or resins (the “binder”), and absorbent particles. The ink-receptive coating composition could also be solvent-based. Examples of suitable polymers and resins include, without limitation, water soluble or dispersible film-forming polymers and/or latex polymers such as poly(vinyl alcohol), poly(vinyl acetate), copolymers of vinyl acetate, hydroxyethyl cellulose, methyl cellulose, carboxy methyl cellulose, starch, gum arabic, polyethylene glycol poly(vinyl pyrrolidone), polyacrylamide, polypropylene glycol, gelatin, and combinations of these. The ink-receptive coating may also be formulated with materials that cure by exposure to actinic radiation, particularly free-radical curing monomers and oligomers and cationically-curing monomers and oligomers. Examples of absorbent particles include, without limitation, highly porous silica, cationic, porous inorganic oxides, particularly silica gels such as silica hydrogels, aerogels, xerogels, cogels, and other inorganic oxides such as alumina, silica/alumina, and titania as well as polymeric absorbents such as crosslinked PVP polymer particles. In general, inorganic oxides having pore volumes of 0.6 cc/g or more are preferred, particularly those having pore volumes of 0.6 to 3.00 cc/g are suitable. Also in general, the average particle size should be in the range of 1 to 20 microns, preferably about 3 to about 12 microns, particularly preferably about 5 to about 8 microns.

To give the ink-receptive coating an aesthetically pleasing appearance, the gloss of the coating may be increased a desired amount and/or the ink-receptive coating may be colored by addition of one or more colorants, which may be selected from dyes and/or pigments. The gloss of the ink-receptive coating may be increased by decreasing the amount of absorbent particles relative to the amount of binder and/or by decreasing the average particle size of the absorbent particles. Decreasing the relative amount or average particle size of the absorbent particles may increase the dry time for the coating if the coating is not dried with a heater or cured by actinic radiation. In such a case, the increase in gloss and dry time may be balanced to the best advantage for the particular printing equipment and print job. The ink receptive coating may be colored by addition of colorants to obtain a desired color. Suitable examples of colorants that may be employed include, without limitation, titanium dioxide, ink jet grade dyes, and water- and solvent-dispersed, colored pigments. In general, any dye or pigment that could be used in a water or solvent based coating may be employed.

The porous, absorbent particles may be included at amounts of 0.1 to 80 percent by weight, preferably at least about 25 percent by weight, of the nonvolatile components of the ink-receptive coating composition. Higher amounts of porous, absorbent particles allow the printed surface of the coating to be resistant to blocking after little actual drying of the waterborne ink jet ink. Instead of drying, the ink is absorbed into the porous particles, which prevent smearing and release the water from the ink over time.

In various embodiments, ink-receptive coating compositions may include other components such as optical brighteners, crosslinking agents such as dryers for the polymer or resin, dispersants, lubricants, preservatives, anti-foam surfactants, drop size modifiers, color tastness additives, and so on.

In general, the coating composition is applied at rates of about 2 to about 30 g/m², preferably from about 10 to about 20 g/m². The ink-receptive coating can be applied in the desired area or areas using conventional printing methods such as flexography, gravure, pad printing, spray deposition, and so on. The coating is applied to areas that will receive variable print. Variable print is typically applied to a specific area of print stock, for instance a bar code applied on the bottom or back of packaging, an address applied in a corner on the front of a magazine cover, personalization on a product, or short- or special-run advertising that may be placed anywhere on a product.

The ink receptive coating may be formulated to be curable on exposure to actinic radiation, in which case the printing station may include a source of actinic radiation to which the coating is exposed after application to the substrate. In various embodiments, the print station may include a heater for at least partially drying the applied coating. The applied coating layer can be dried, for example, at room temperature, by hot air drying, heat surface-contact drying, or heat radiation drying. Curable applied coating layers can be cured under appropriate conditions, such as thermally or by exposure to actinic radiation, as mentioned.

The substrate may be printed with repetitive print at other print stations of the press, typically using process colors (e.g., CMYK) for full color print.

The aqueous ink jet ink may be applied, for example, with single jet or high speed, binary array printer such as Scitex Kodak Versamark 6240, Domino A300, Videojet Printpro, as well as printers based on Hewlett Packard or other TIJ head technology and PIJ head technology from Spectra, Xaar, Epson or others. Typically, the ink jet printer is used to apply variable text, numbers, bar codes, or graphics in the selected areas that have been coated with the ink-receptive coating. For example, a cover of a glossy magazine printed on a conventional web press (flexo or gravure) receives coating in selected areas, which could be over part of the repetitive print or on unprinted areas, at one printing station and variable text such as mailing address, subscription information, and bar codes may be printed with waterborne ink by a continuous ink jet printer. The aesthetically pleasing appearance of the coating lets the coated area or areas blend in with the repetitive print on the rest of the substrate or provides a highlight or contrasting color. The coating may have an amount of gloss which makes it like, or more like, the gloss of the rest of the magazine cover, for example. In another example, the coating may be colored to match an area that receives the coating or to provide a highlighted or contrasting color area for the variable print.

The ink-receptive coating and water-based ink jet ink may be applied onto nonabsorbent and semi-nonabsorbent stock that has already been printed. For example, as illustrated in FIG. 2, printed, nonabsorbent or semi-nonabsorbent substrates, for example magazines with glossy covers, are imprinted using a mail table. On one side of the mail table is a stack 102 of magazine cover sheets having nonabsorbent or semi-nonabsorbent surfaces. The sheets are passed one by one through print station 103, which may be, for example, a flexographic print station or a gravure print station. Print station 103 applies an ink-receptive coating in one or more areas or “knock outs” on the sheet. Print station 103 includes a heater or other unit to at least partially dry the applied coating, after which the sheet passes to an ink jet print head 104. Ink jet printhead 104 applies a variable print using a waterborne ink. The printed sheet may then pass to a heater [not shown] or actinic radiation source [not shown], as appropriate for the particular waterborne ink selected. The sheet then passes to stack 105 of sheets printed with variable print. A mail table typically enables medium or high speed, off-line printing of variable text, while variable text can be applied at very high speed in an in-line process such as that discussed with reference to FIG. 1.

FIG. 3 illustrates a portion of a sheet printed with variable print. Sheet section 201 has an area 202 of full-color, glossy print and a “knock out” area 203 with an ink-receptive coating. Inside the “knock out” area 203 is representative variable text printed with an aqueous continuous ink jet ink. The coating in the “knock-out” area 203 may have a gloss and/or color similar to a part of area 202, and/or a color that contrasts to the area around the knock-out area 203.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of printing an aqueous ink on at least one selected area of a nonabsorbent and semi-nonabsorbent substrate, comprising steps of:
applying an ink-receptive coating having an aesthetically pleasing appearance to the selected area of the substrate,
at least partially drying the coating,
and printing an aqueous ink jet ink on the coating.

2. A method according to claim 1, wherein the ink-receptive coating is applied using a flexographic printing station, a gravure printing station, or pad printing.

3. A method according to claim 1, wherein the ink-receptive coating includes a colorant.

4. A method according to claim 1, wherein the ink-receptive coating has a semi-gloss or glossy appearance.

5. A method according to claim 4, wherein the coating is at least partially dried with heat or is cured by exposure to actinic radiation or thermally or both by exposure to actinic radiation and thermally.

6. A method of printing variable print in selected areas on a nonabsorbent or semi-nonabsorbent web or roll of a substrate, comprising steps of:
applying an ink-receptive coating having an aesthetically pleasing appearance to the selected areas,
at least partially drying the coating,
and printing an aqueous ink jet ink on the coating in variable print.

7. A method according to claim 6, wherein the ink-receptive coating is applied using a print station of a web flexographic or gravure press or by pad printing.

8. A method according to claim 7, wherein repetitive print is applied at one or more additional print stations of the press.

9. A method according to claim 7, wherein the ink-receptive coating has a glossy or semi-gloss appearance and further wherein the print station includes a thermal dryer.

10. A method according to claim 7, wherein the ink-receptive coating has a glossy or semi-gloss appearance and further wherein the ink-receptive coating is cured.

11. A method of continuously printing variable print in selected areas on sheets of nonabsorbent or semi-nonabsorbent substrate, comprising steps of:
applying to the selected area on each sheet an ink-receptive coating having an aesthetically pleasing appearance;
at least partially drying the coating; and
printing an aqueous ink jet ink in variable print in the area by a continuous ink jet printer.

12. A method according to claim 11, wherein the ink-receptive coating includes a colorant.

13. A method according to claim 12, wherein the ink-receptive coating is colored to match a highlighted area on which it is applied.

14. A method according to claim 11, wherein the ink-receptive coating has a gloss with an acceptable match to gloss in an adjacent area of each sheet.

15. A method according to claim 11, wherein, in the variable print is selected from the group consisting of variable text, variable numbers, variable bar codes, and variable graphics.

16. A method according to claim 11, wherein the method is carried out using a mail table.

17. A method according to claim 16, wherein the applied coating is at least partially dried or cured before printing the aqueous ink jet ink.

18. A method of printing variable text on nonabsorbent or semi-nonabsorbent printed substrate using a printing press having multiple print stations, comprising steps of:
applying repetitive print with one to less than all of the print stations;
applying an ink-receptive coating in a selected area of the substrate with one of the print stations;
at least partially drying or curing the ink-receptive coating; and
applying a waterborne ink in the area of the ink receptive coating to form a variable print using an ink jet printer,
wherein the ink-receptive coating has an aesthetically pleasing appearance.

20. A method according to claim 19, wherein the coating is applied over a part of the substrate having a highlight color, and further wherein the coating is colored to have an acceptable color match to the highlight color.

21. A printed web comprising variable print in a desired area, wherein the desired area is coated with an ink-receptive coating having an aesthetically pleasing appearance.

22. A printed web according to claim 21, wherein the aesthetically pleasing appearance has an acceptable color match to an area adjacent to the desired area.

23. A printed web according to claim 21, wherein the aesthetically pleasing appearance has an acceptable match in gloss to an area adjacent to the desired area.
